(19) United States
(12) Patent Application Publication
(10) Pub. No.: US 2009/0264281 A1
(43) Pub. Date: Oct. 22, 2009

(54) Metal alloy for electrochemical Oxidation reactions and method of production thereof

(76) Inventors: Lixin cao, Princeton, NJ (US); Yu-Min Tsou, Princeton, NJ (US); Emory S. DeCastro, Nahant, MA (US)

Correspondence Address: Charles A. Muserlian;c/o Hedman and Costigan, 1185 Avenue of the Americas, New York, NY, 10036, US

(21) Appl. No.: 12/456,820

(22) Filed: Jun. 23, 2009

Related U.S. Application Data
(62) Division of application No. 11/173,095, filed on Jul. 1, 2005.
(60) Provisional application No. 60/588,544, filed on Jul. 16, 2004.

(51) Int. Cl. B01J 23/42; H01M 4/92

(52) U.S. Cl. 502/101; 502/339

(57) ABSTRACT

A method of production of highly alloyed supported or unsupported platinum-ruthenium catalysts by simultaneous precipitation of the corresponding hydrous oxides or hydroxides and subsequent reduction wherein the simultaneous precipitation of platinum and ruthenium hydrous oxides is made possible by mixing two separate precursor solutions of the two metals, one in acidic and the other in basic environment, until reaching a near-neutral pH at which both hydrous oxide species are insoluble.

### PRIOR APPLICATION

This is a non-provisional application of provisional application Ser. No. 60/588,544 filed Jul. 16, 2004.

The invention is relative to a catalyst for electro-oxidation reactions and, in particular, to a binary platinum-ruthenium alloy suitable as the active component of a direct methanol fuel cell anode.

### BACKGROUND OF THE INVENTION

Direct methanol fuel cells (DMFC) are widely known membrane electrochemical generators in which oxidation of pure methanol or an aqueous methanol solution occurs at the anode. As an alternative, other types of light alcohols such as ethanol, or other species that can be readily oxidized such as oxalic acid, can be used as the anode feed of a direct type fuel cell, and the catalyst of the invention can be also useful in these less common cases.

In comparison to other types of low temperature fuel cells, which generally oxidize hydrogen, pure or in admixture, at the anode compartment, DMFC are very attractive as they make use of a liquid fuel, which gives great advantages in terms of energy density and is much easier and quicker to load. On the other hand, the electro-oxidation of alcohol fuels is characterized by slow kinetics, and requires finely tailored catalysts to be carried out at current densities and potentials of practical interest. DMFC have a strong thermal limitation as they make use of an ion-exchange membrane as the electrolyte, and such component cannot withstand temperatures much higher than 100° C.: this affects the kinetic of oxidation of methanol or other alcohol fuels in a negative way and to a great extent, and the quest for improving the anode catalysts has been ceaseless at least during the last twenty years.

It is well known to those skilled in the art that the best catalytic materials for the oxidation of light alcohols are based on binary or ternary combinations of platinum and other noble metals. In particular, platinum-ruthenium binary alloys are largely preferred in terms of catalytic activity and stability, and they have been used both as catalyst blacks and as supported catalyst, for example on active carbon, and in most of the cases incorporated into gas diffusion electrode structures suited to be coupled to ion-exchange membranes. Platinum and ruthenium are, however, very difficult to combine into true alloys: the typical Pt:Ru 1:1 combination disclosed in the prior art almost invariably results in a partially alloyed mixture. The method for the production of binary combinations of platinum and ruthenium of the prior art starts typically from the co-deposition of either mixed oxide or hydroxide particles of suitable compounds of the two metals or co-deposition of the colloidal metal particles on a carbon support.

For example, one possible way of catalyst preparation starts from U.S. Pat. No. 3,992,512 wherein the preparation of a platinum sulfite compound “H₃Pt(SO₃)₂OH” (PSA) is disclosed and a corresponding RuSA may be prepared by the same route. These precursors were then reacted with hydrogen peroxide and adsorbed on carbon support followed by reduction. This process frequently leads to alloy catalysts containing sulfur and/or amorphous oxide phases. Bonnemann et al (Angew, Chem., Int. Ed. Engl. 1991, 30, p. 804) a method based on a surfactant shell stabilizing mixed Pt and Ru colloid particles in organic solvent. However, after the colloid particles are adsorbed on support, a “reactive annealing process” is needed to remove the surfactant. The process is very complicated and has the risk of ignition during annealing; therefore, not suitable for commercialization. In Lee et al (J. Electrochem. Soc. 2002, 149 (10), A11299) there is presented a new method based on reduction of metal chlorides with LiBH₄ in THF to form alloy colloidal particles followed by collection on carbon. Besides being a complicated procedure and using toxic organic solvents, the method led to catalysts with substantial amount of amorphous phases.

Besides the aforementioned drawbacks, these prior methods do not necessarily lead to catalysts with desirable features and sometimes also have other limitations. It is known in the field that to be a good PtRu alloy for methanol oxidation, the two elements need to have good mixing at atomic scale. For example, the oxidation of PSA and RuSA is a slow and incomplete process, resulting in a mixed hydrous oxide containing some amount of sulfur. Moreover, reduction of the mixed hydrous oxides requires high temperature which tends to induce phase separation. Reduction with LiBH4 in THF was found also to be an incomplete process. The method based on shell-stabilized colloidal in organic solvent can only make catalysts with total metal loadings less than 30%. Methanol oxidation application usually requires loading higher than 60%.

### OBJECTS OF THE INVENTION

It is an object of the invention to provide a method for obtaining highly alloyed platinum-ruthenium combination exhibiting a high catalytic activity towards the oxidation of methanol and other organic fuels.

It is another object of the invention to provide a catalyst with high activity for the oxidation of hydrogen gas in the presence of CO, such as that encountered in reformate used in PEM fuel cells.

It is yet another object of the invention to provide an electrochemical process for highly efficient oxidation of light organic molecules.

These and other objects and advantages will become obvious from the following detailed description.

### SUMMARY OF THE INVENTION

Under one aspect, the invention consists of a method for the production of alloyed platinum-ruthenium catalysts starting from a platinum and ruthenium precursor complex, comprising a neutralization step in which one complex in acidic, i.e., low pH solution is slowly added to the other complex in alkali, i.e., a high pH solution, or vice versa. This mixing process leads to the pH of the mixture gradually shifting toward a pH where both complexes are not soluble. In other words, insoluble hydrous oxides or hydroxides are formed in the pH range of 4-10. This allows the simultaneous formation of metal hydroxide/oxide precipitation with very thorough mixing. Under another aspect, the subsequent reduction leads to the mixing of two metal elements in atomic scale.

Under a third aspect, the invention consists in an electrochemical process of oxidation of methanol or other fuel at the anode compartment of a fuel cell equipped with a platinum-ruthenium alloyed catalyst obtained by simultaneous precipitation of hydrous hydroxides/oxides and followed by reduction of hydrous hydroxide/oxides.

### BRIEF DESCRIPTION OF THE DRAWINGS

FIG. 1 is a graph of the XRD spectrum of PTₓRu_{y} of Examples 1 to 3, 5 and 7.

FIG. 2 is a graph of methanol oxidation with Examples 8, 10 and 12.

FIG. 3 is a graph of methanol oxidation with Examples 2 and 12.

FIG. 4 is a graph of methanol oxidation with Example 3 and other samples.

FIG. 5 is a graph of methanol oxidation with Examples 3 to 7.

### DETAILED DESCRIPTION OF THE PREFERRED EMBODIMENTS

The chemistry of platinum and ruthenium is such that if hydroxide ions are introduced to an acidic solution of the mixed metal complexes, hydrous ruthenium oxide will form instantaneously whereas hydrous platinum oxide forms at a much slower rate. This inevitably causes phase separation in the mixed hydrous oxide precursor and results in phase separated Pt and Ru phase after reduction.

To solve this problem, the applicants invented a new chemical process. The method takes advantage of unique platinum chemistry—platinic acid, H₂Pt(OH)₆ is soluble in high pH or alkali solutions such as K₂CO₃ Na₂CO₃, KOH, or NaOH solution to form K₂H₂Pt(OH)₆, or NaₓH₂₋ₓPt(OH)₆, but not in a neutral solution. When the pH of the solution is lowered, the precipitation of hydrous platinum oxide can be induced. A key step for the simultaneous formation of mixed hydrous oxides together is the use of Ru compounds as the acidic agent to decrease the pH. In this method, the two metal complexes were brought together starting from solutions at different pHs where they are soluble (acidic for Ru, but basic for Pt) to reach a pH, between 4 and 10, preferably around 4-8.5, where they are both insoluble so that simultaneous precipitation is rendered.

In one preferred embodiment, a neutralization reaction is carried out by adding an acidic RuCl₃ solution to a solution containing Pt^{iv}(H₂O)(OH)₅ or Pt^{iv}(OH)₆ and K₂CO₃.

RuCl₃+H₂Pt(OH)₆+K₂CO₃→Ru(H₂O)ₐ(OH)₃+Pt(H₂O)_{b}(OH)₄→Ru₂O₃xH₂O+PtO₂yH₂O

The solution of RuCl₃xH₂O has a pH about 1.5 because of the dissociation:

RuCl₃(H₂O)₃→RuCl₃(H₂O)(OH)⁻+H⁺.

The precipitated hydrous RuO2 and hydrous PtO2 can be adsorbed on carbon substrates, preferably high surface area conductive carbon blacks such as Vulcan-72 or Ketjenblack. The adsorbed mixed-oxide particles can be reduced in-situ to adsorbed alloy by reducing agents such as formaldehyde, formic acid, borate, or phosphate, etc. It can also be reduced to alloy after filtering and drying in a stream of hydrogen or hydrogen/inert gas mixture at an elevated temperature.

In the following examples, there are described several preferred embodiments to illustrate the invention. However, it should be understood that the invention is not intended to be limited to the preferred embodiments.

### Example 1

### 89% PtRu on Ketien Black EC Carbon (Lion's Corporation, Japan)

80% PtRu on Ketjen black EC carbon was prepared as follows: 8 g of Ketjen black EC carbon were dispersed in 280 ml of de-ionized water with ultrasound Corn for 5 minutes. 27.40 g of K2CO3 were dissolved in 2720 ml of de-ionized water. 32.94 g of dihydrogen hexahydroxyplatinate (or so-called platinic acid (PTA), H₂Pt(OH)₆, ˜64% Pt) were added to the K2CO3 solution under heating and stirring until it was completely dissolved. The ketjen black slurry was subsequently transferred to the PTA+K₂CO₃ solution. After the mixture was boiled for 30 min, a RuCl₃ solution comprising 26.76 g RuCl₃.xH₂O (˜40.82 wt % Ru) in 500 ml of de-ionized water was added to the slurry at a rate of 15 ml/min. The slurry was stirred for 30 min at the boiling point. 19.2 ml of 37 wt % formaldehyde diluted to 100 ml were added to the slurry at a rate of 5 ml/min. The temperature was maintained at the boiling point for 30 min. The slurry was filtered and then washed with 1 liter of de-ionized water five times. The catalyst cake was dried at 80° C. under vacuum. The final sample was ball milled for one hour.

### Example 2

### 60% PtRu on Ketien black EC Carbon (Lion's Corporation, Japan)

60% PtRu on Ketjen black EC carbon was prepared as follows: 20 g of Ketjen black EC carbon were dispersed in 70 ml of de-ionized water with Silverson for 15 min. 25.69 g of K₂CO₃ K₂CO₃ were dissolved in 2250 ml of de-ionized water. 30.88 g PTA were dissolved in the K₂CO₃ solution with the assistance of heating and stirring. The ketjen black slurry was subsequently transferred to the PTA+K₂CO₃ solution. After the mixture was boiled for 30 minutes, a RuCl₃ solution comprising 25.08 g RuCl3.xH2O in 500 ml of de-ionized water was added to the slurry at a rate of ˜15 ml/min. The slurry was stirred for 30 minutes at the boiling point. 18.0 ml of 37 wt % formaldehyde diluted to 100 ml with de-ionized water were added to the slurry at a rate of 5 m/min. The temperature was maintained at the boiling point for 30 minutes. The slurry was filtered and washed with 1 liter de-ionized water repeatedly five times. The catalyst cake was dried at 80° C. under vacuum and the final sample was ball milled for one hour.

### Example 3

### PtRu Black with an Atomic Ratio of 1:1

PtRu black was prepared as follows: 25.69 g of K₂CO₃ were dissolved in 3,000 ml of de-ionized water. 30.88 g of PTA were dissolved in the K₂CO₃ solution with the assistance of heating and stirring. After the mixture was boiled for 30 minutes, the RuCl₃ solution comprising 25.08 g of RuCl₃.xH₂O in 500 ml of de-ionized water was added to the K₂CO₃+PTA solution at a rate of ˜15 ml/min. The precipitate was stirred for 30 minutes at the boiling point. 18.0 ml of 37 wt % formaldehyde diluted to 100 ml were added to the precipitate at a rate of 5 ml/min. The temperature was maintained at the boiling point for 30 minutes. The precipitate was filtered, washed with 1 liter of de-ionized water repeatedly five times. The catalyst cake was dried at 80° C. under vacuum and the final sample was ball milled for one hour.

### Example 4

### PtRu Black with an Atomic Ratio of 1:3

PtRu₃ black was prepared as follows: 14.97 g of K₂CO₃ were dissolved in 1000 ml of de-ionized water. 6.12 g of PTA were dissolved in the K₂CO₃ solution with the assistance of heating and stirring. After the mixture was boiled for 30 minutes, the RuCl₃ solution comprising 14.91 g of RuCl₃.xH₂O in 400 ml of de-ionized water was added to the K₂CO₃+PTA solution at a rate of 15 ml/min. The precipitate was stirred for 30 minutes at the boiling point. 6.35 g of 37 wt % formaldehyde diluted to 100 ml were added to the precipitate at a rate of 5 ml/min. The temperature was maintained at the boiling point for 30 minutes. The precipitate was filtered and washed with 1 liter of de-ionized water repeatedly five times. The catalyst cake was dried at 80° C. under vacuum and the final sample was ball milled for one hour.

### Example 5

### PtRu Black with an Atomic Ratio of 1:2

PtRu₂ black was prepared as follows: 12.54 g of K₂CO₃ were dissolved in 1000 ml of de-ionized water. 7.67 g of PTA were dissolved in the K₂CO₃ solution with the assistance of heating and stirring. After the mixture was boiled for 30 minutes, the RuCl₃ solution comprising 12.47 g of RuCl₃.xH2O in 400 ml of de-ionized water was added to the K₂CO₃+PTA solution at a rate of 15 ml/min. The precipitate was stirred for 30 minutes at the boiling point. 6.13 g of 37 wt % formaldehyde diluted to 100 ml were added to the precipitate at a rate of 5 ml/min. The temperature was maintained at the boiling point for 30 minutes. The precipitate was filtered, washed with 1 liter of de-ionized water repeatedly five times. The catalyst cake was dried at 80° C. under vacuum and the final sample was ball milled for one hour.

### Example 6

### PtRu Black with an Atomic Ratio of 2:1

Pt₂Ru black was prepared as follows: 10.32 g of K₂CO₃ were dissolved in 1250 ml of de-ionized water. 12.41 g of PTA were dissolved in the K₂CO₃ solution with the assistance of heating and stirring. After the mixture was boiled for 30 minutes, the RuCl₃ solution comprising 5.04 g of RuCl₃.H2O and 5.00 g of acetic acid (99.9%) in 250 ml of de-ionized water was added to the K₂CO₃+PTA solution at a rate of 10 ml/min. The precipitate was stirred for 30 minutes at the boiling point. 6.8 g of 37 wt % formaldehyde diluted to 100 ml were added to the precipitate at a rate of 5 ml/min. The temperature was maintained at the boiling point for 30 minutes. The precipitate was filtered and washed with 1 liter of de-ionized water repeatedly five times. The catalyst cake was dried at 80° C. under vacuum and the final sample was ball milled for one hour.

### Example 7

### PtRu Black with an Atomic Ratio of 3:1

Pt₃Ru black was prepared as follows: 11.08 g of K₂CO₃ were dissolved in 1250 ml of de-ionized water. 13.32 g of PTA were dissolved in the K₂CO₃ solution with the assistance of heating and stirring. After the mixture was boiled for 30 minutes, the RuCl₃ solution comprising 3.61 g of RuCl₃.xH2O and 6.60 g of acetic acid (99.9%) in 250 ml of de-ionized water was added to the K₂CO₃+PTA solution at a rate of ˜10 ml/min. The precipitate was stirred for 30 minutes at the boiling point. 5.76 g of 37 wt % formaldehyde diluted to 100 ml were added to the precipitate at a rate of 5 ml/min. The temperature was maintained at the boiling point for 30 minutes. The precipitate was filtered and washed with 1 liter of de-ionized water repeatedly five times. The catalyst cake was dried at 80° C. under vacuum and the final sample was ball milled for one hour.

### Example 8

### 30% Pt:Ru on Vulcan XC-72

30% Pt:Ru on Vulcan XC-72 was prepared as follows: 70 g of Vulcan XC-72 were dispersed in 2.5 liter of de-ionized water with Silverson for 15 minutes. 25.69 g of K₂CO₃ were dissolved in 500 ml of de-ionized water. 30.88 g of PTA were dissolved in the K₂CO₃ solution with the assistance of heating and stirring. The K₂CO₃+PTA solution was subsequently transferred to the carbon black slurry. After the mixture was boiled for 30 minutes, the RuCl₃ solution comprising 25.08 g of RuCl₃.xH₂O in 500 ml of de-ionized water was added to the slurry at a rate of ˜15 ml/min. The slurry was stirred for 30 minutes at the boiling point. 18.0 ml of 37 wt % formaldehyde diluted to 100 ml were added to the slurry at a rate of 5 mL/min. The temperature was maintained at the boiling point for 30 minutes. The slurry was filtered, washed with 1 liter of de-ionized water repeatedly five times. The catalyst was dried at 80° C. under vacuum and the final sample was ball milled for 1 hour.

### Example 9

### 40% Pt:Ru on Vulcan XC-72

40% PT:Ru on Vulcan XC-72 was prepared as follows: 48 g of Vulcan XC-72 were dispersed in 1.48 liters of de-ionized water with Silverson for 15 minutes. 27.40 g of K₂CO₃ were dissolved in 500 ml of de-ionized water. 32.94 g of PTA were dissolved in the K₂CO₃ solution with the assistance of heating and stirring. The K₂CO₃+PTA solution was subsequently transferred to the carbon black slurry. After the mixture was boiled for 30 minutes, the RuCl₃ solution comprising 26.76 g of RuCl₃.xH₂O in 500 ml of de-ionized water was added to the slurry at a rate of 15 mL/min. The slurry was stirred for 30 minutes at the boiling point. 19.2 ml of 37 wt % formaldehyde diluted to 100 ml were added to the slurry at a rate of 5 mL/min. The temperature was maintained at the boiling point for 30 minutes. The slurry was filtered and washed with 1 liter of de-ionized water repeatedly five times. The catalyst cake was dried at 80° C. under vacuum and the final sample was ball milled for 1 hour.

### Comparative Example 10

### 30% Pt:Ru on Vulcan XC-72 by Prior Art I

Control sample 30% Pt:Ru on Vulcan XC-72 was prepared as follows: 10 liters of de-ionized water were mixed 512 ml of 40 g/l of ruthenium sulfite acid (H3Ru(SO3)2OH) and 197.6 ml of 200 g/l of platinum sulfite acid (H3Pt(SO3)2OH) in a Teflon-lined bucket with stirring. The solution pH was adjusted to 4.0 with a dilute solution of NH₄OH. 140 g of Vulcan XC-72 carbon support were added to the solution with stirring. 1000 ml of 30% H₂O₂ were slowly added to the slurry at a rate of 2˜4 ml/min. After the addition was complete, the slurry was stirred for 1 hour at ambient temperature and the pH was adjusted to 4.0. Another 600 ml of 30% H₂O₂ were then added. The slurry was stirred for another 1 hour while the pH was maintained at 4.0. The slurry temperature was brought to 70° C. and held at 70° C. for 1 hour while the pH was maintained at 4.0. The hot catalyst slurry was filtered and washed with 1.0 liter of hot de-ionized water. The catalyst was dried at 125° C. for 15 hours and was reduced with H₂ at 230° C.

### Comparative Example 11

### 60% Pt:Ru on Vulcan XC-72 by Prior Art I

60% Pt:Ru on Vulcan XC-72 was prepared as follows: 10 liters of de-ionized water were mixed with 512 ml of 40 g/l ruthenium sulfite acid and 197.6 ml of 200 g/l platinum sulfite acid in a Teflon-lined bucket with stirring. The solution pH was adjusted to 4.0 with a dilute solution of NH₄OH. 40 g of Vulcan XC-72 carbon support were added to the solution with stirring. 1,000 ml of 30% H2O2 were slowly added to the slurry at a rate of 2˜4 ml/min. After the addition was complete, the slurry was stirred for 1 hour at ambient temperature and the pH was adjusted to 4.0. Another 600 ml of 30% H202 were then added. The slurry was stirred for another 1 hour while the pH was maintained at 4.0. The slurry temperature was brought to 70° C. and held at 70° C. for 1 hour while the pH was maintained at 4.0. The hot catalyst slurry was filtered and washed with 1.0 liters of hot de-ionized water. The catalyst was dried at 125° C. for 15 hours and was reduced with H2 at 230° C.

### Comparative Example 12

### 30% Pt:Ru on Vulcan XC-72 by Prior Art II

30% Pt:Ru on Vulcan XC-72 was prepared as follows: 35 g of Vulcan XC-72 were suspended in 1.0 liters of acetone with vigorous stirring for 10 minutes. In a separate 5 liter flat-bottom flask, 21.9 g of Pt(acac)₂ and 22.2 g of Ru(acac)₃ (acac=acetylacetonate) were dissolved in 1.5 liters of acetone. The carbon dispersion was then mixed with Pt/Ru solution in the flask. The resulting mixture was stirred for 30 minutes while the flask was maintained at 25° C. by means of a water bath. The slurry so obtained was sonicated for 30 minutes and then evaporated by placing the flask in a water bath at 60° C. Acetone was collected with a condenser. The dry catalyst cake was ground to fine powder, which was transferred to a tubular reactor and was heated in an argon stream to 300° to ensure the complete decomposition of Pt and Ru precursors. The catalyst was finally reduced in 15% H₂/Ar stream for 3 hours.

### Analysis of Samples

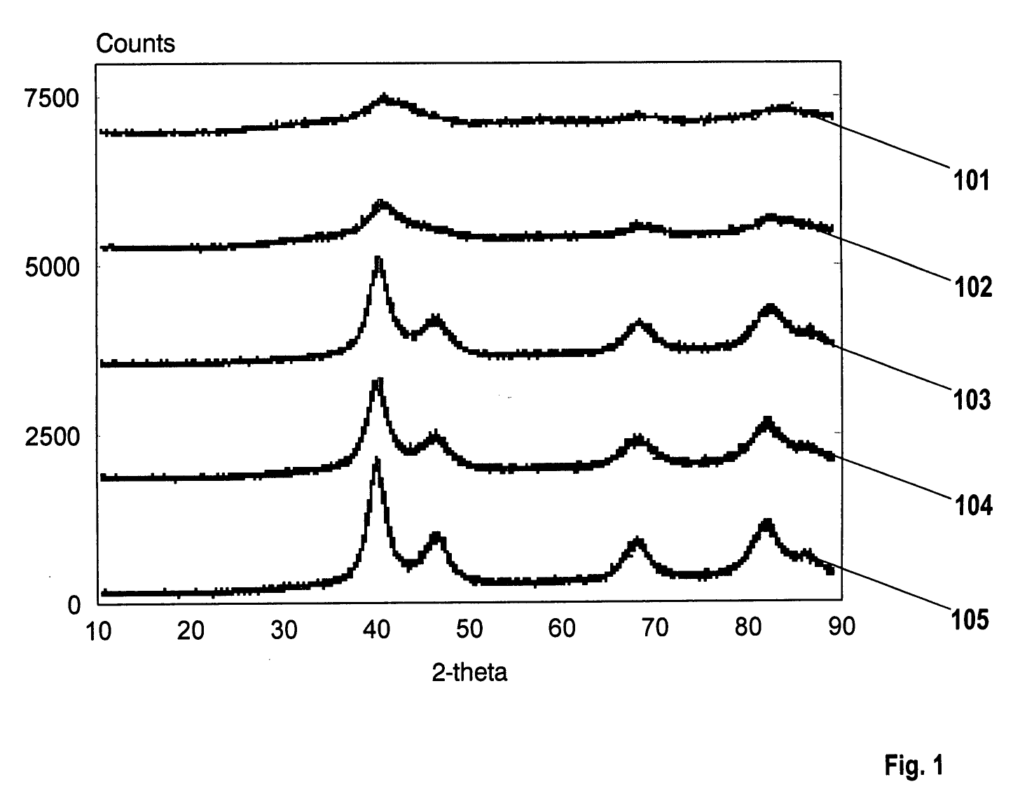

The nine catalysts obtained in the previous examples were subjected to X-ray diffraction (XRD) analysis. The Scherrer equation was used to calculate the crystallite size based on X-ray broadening analysis. Usually for a PtRu alloy with higher Pt content, the crystal will have a face-centered crystal like the pure platinum crystal. The existence of ruthenium atom just substituted for platinum atom and results in the reduction of the lattice parameters. The alloy phase composition can be calculated from the position of the 220 peak if the alloy has an identical XRD pattern with only peak position change and slight shape modification. If the calculated “atomic scale XRD Pt:Ru ratio” is very close to the bulk Pt:Ru ratio, the catalyst is judged to be a good alloy. Otherwise, significant single metal phase, either in crystalline or amorphous phase must exist. Examples 4 and 5 (FIG. 1) had different XRD patterns from other samples because they have higher ruthenium percentage than Pt percentage. This is clearly shown in FIG. 1, where the XRD spectra corresponding to five catalysts in accordance with the invention are reported. The curves are relative to samples of PtRu₃ from Example 4 (101), PtRu₂ from Example 5 (102), PtRu from Example 3 (103), Pt₂Ru from Example 6 (104) and Pt₃Ru from Example 7 (105), respectively. Nearly complete Pt:Ru alloys were formed in Examples 1 to 3 and 6 to 8, in which PTA and RuCl₃ were used as precursors. On the other hand, the rather large difference for the two ratios (atomic scale ratio and bulk ratio) for sample 9 indicates the existence of significant single metal phase. A shoulder seems to exist in the 220 peak of the XRD graph of sample 9.

The data also shows that the crystallite size is almost independent of metal loading. Example 10 exhibits inferior alloy property since the calculated Pt:Ru ratio deviates significantly from the bulk ratio, 50:50. The XRD spectra of both samples 10 and 11 indicated a significant amount of single ruthenium metal phase (as shown by the broadening of 46 2-theta peak into a shoulder) and amorphous RuO₂ phase. EDAX analysis also pointed to sulfur amount about 34 times of the background level—presumably from the precursor sulfite complexes. These factors cause the inferior RDE performances of samples 10 and 11 as will be described below. Despite the very close match between atomic scale XRD Pt:Ru ratio and bulk Pt:Ru ratio, catalyst in Example 12 prepared with Pt(acac)₂ and Ru(acac)₃ has significant amount of amorphous phase and possibly single metal phase as shown in XRD spectra.

These factors could lead to the inferior performances as compared with catalysts in the present invention (see RDE test below). Usually metal black catalysts are rather difficult to be controlled at small size. For the PtRu black catalysts prepared with the present invention, the crystalline size of all of them are in the range of 2.4-3.2 nm. It shows the superior consistency in controlling the crystalline size for the present invention. For all catalysts of the present invention, the atomic scale PtRu ratios are also very close to bulk ratios, indicating very homogeneous alloy is formed with minimum amount of single metal phase.

TABLE
Crystallite size and alloy extent analysis evaluated through the (220) peak

| | Pt:Ru | Crystallite | Atomic Scale | | |
|---|---|---|---|---|---|
| Example | loading | size | XRD Pt:Ru | Bulk Pt:Ru | |
| No. | (%) | (nm) | Ratio | Mole ratio | comments |
| 1 | 80 | 2.8 | 49:51 | 50:50 | |
| 2 | 60 | 2.7 | 50:50 | 50:50 | |
| 3 | 100 | 2.8 | 49:51 | 50:50 | |
| 4 | 100 | 2.4 | “26:74” | 25:75 | Different XRD Pattern |
| 5 | 100 | 2.6 | “30:70” | 33:67 | Different XRD Pattern |
| 6 | 100 | 2.6 | 62:38 | 67:33 | |
| 7 | 100 | 3.2 | 66:33 | 75:25 | Shoulder in 220 peak |
| 8 | 30 | 2.6 | 47:53 | 50:50 | |
| 9 | 40 | 2.7 | 48:52 | 50:50 | |
| 10 | 30 | 2.2 | 41:59 | 50:50 | Ru single phase & |
| | | | | | amorphous phase & sulfur |
| | | | | | residue |
| 11 | 60 | 2.4 | 45:55 | 50:50 | Ru single phase & |
| | | | | | amorphous phase & sulfur |
| | | | | | residue |
| 12 | 30 | 2.2 | 47:53 | 50:50 | Ru single phase & |
| | | | | | amorphous phase |

### Rotating Disk Electrode Test

A test of the catalyst performance was conducted by rotating disk electrode (RDE). A dilute ink of carbon-supported catalyst was prepared by mixing 16.7 mg of the supported or unsupported catalyst with 50 ml of acetone. A total of 20 μL of this ink was applied in four coats onto the tip of a glassy carbon rotating electrode of 6 mm diameter.

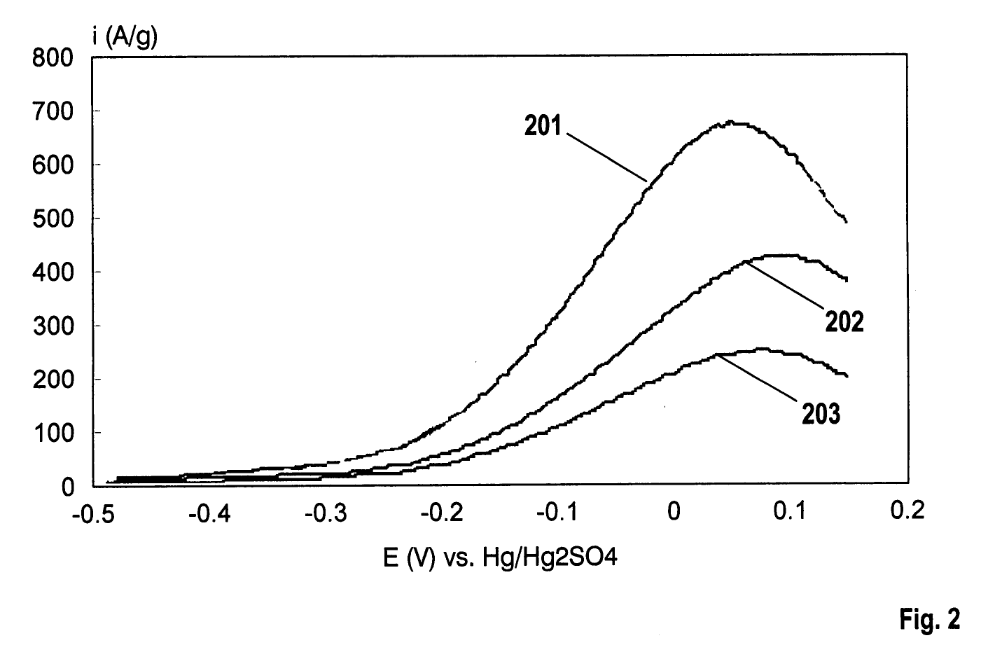

The electrode was placed in a solution of 0.5 M H₂SO₄ containing 1 M of methanol at 50° C. A platinum counter electrode and a Hg/H₂SO₄ reference electrode were connected to a Gamry Potentiostat along with rotator (Pine Instrument) and the rotating disk electrode (Perkin Elmer). Under 1600 RMP, a potential scan was applied (10 mV/s) whereby a plateau representing dissolved methanol oxidation was recorded. The rising portion of the curve was used as the measure for activity towards methanol oxidation. The more negative this rising portion occurs, the more active is the catalyst. FIG. 2 shows that the 30% Pt:Ru (1:1) catalyst prepared with PTA+RuCl₃ method has the best electrochemical activity for methanol oxidation among all the 30% catalysts: (201) indicates the scan relative to the catalyst of the invention prepared in Example 8 and curves (202) and (203) are relative to the prior art samples of Examples 12 and 10, respectively.

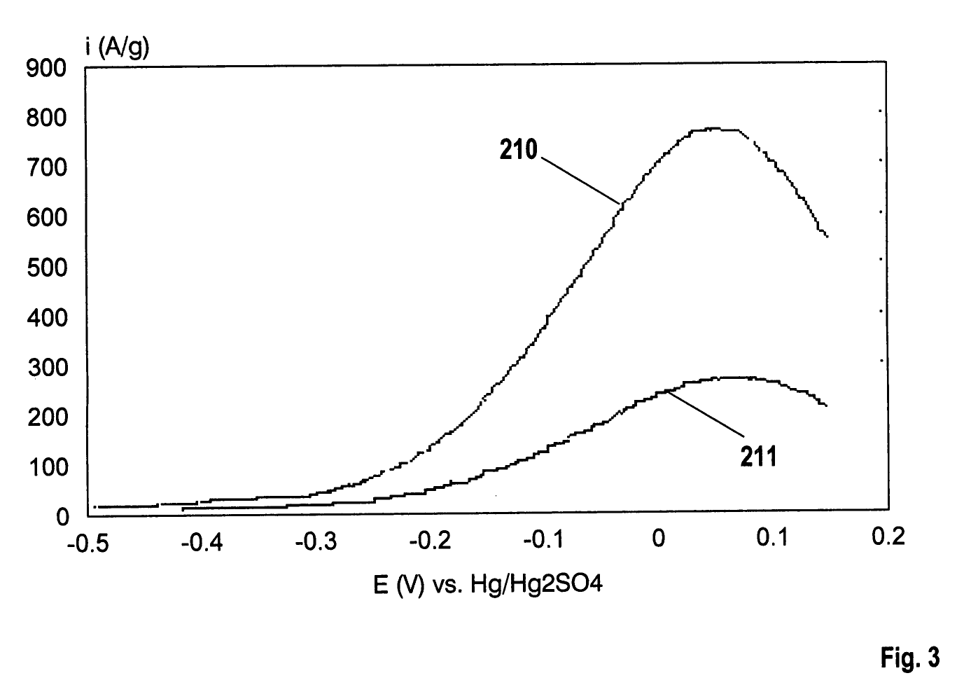

FIG. 3 shows that, at a loading of 60% Pt:Ru (1:1), the catalyst prepared according to the method of the invention gives better performance that the catalyst prepared by the sulfite acid method which results in very poor performance: (210) is the scan relative to Example 2, and (211) is the one for the sample of Example 11.

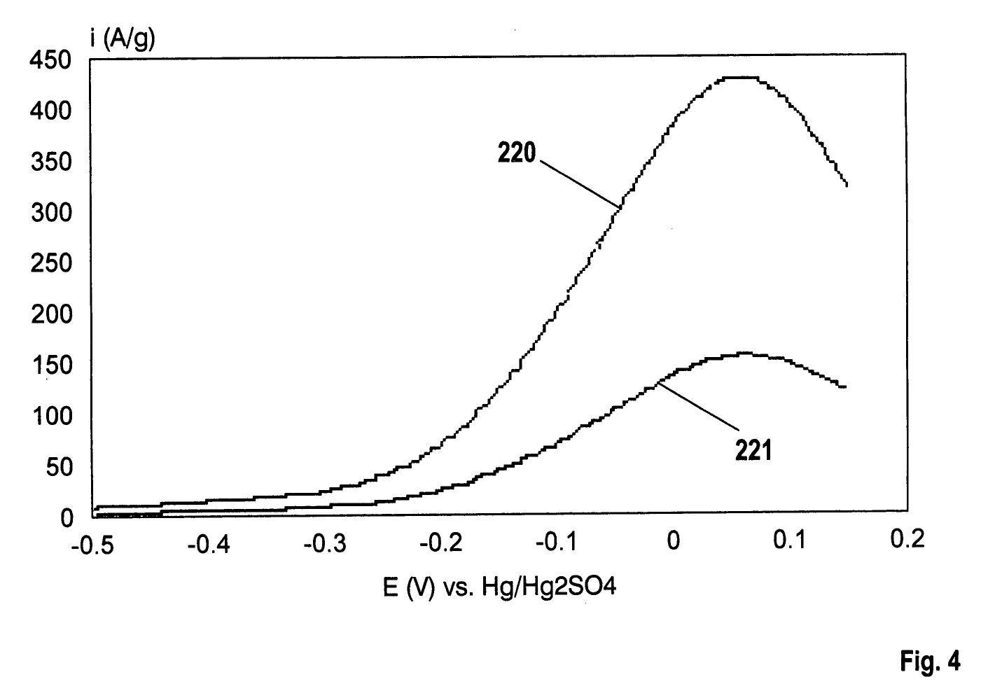

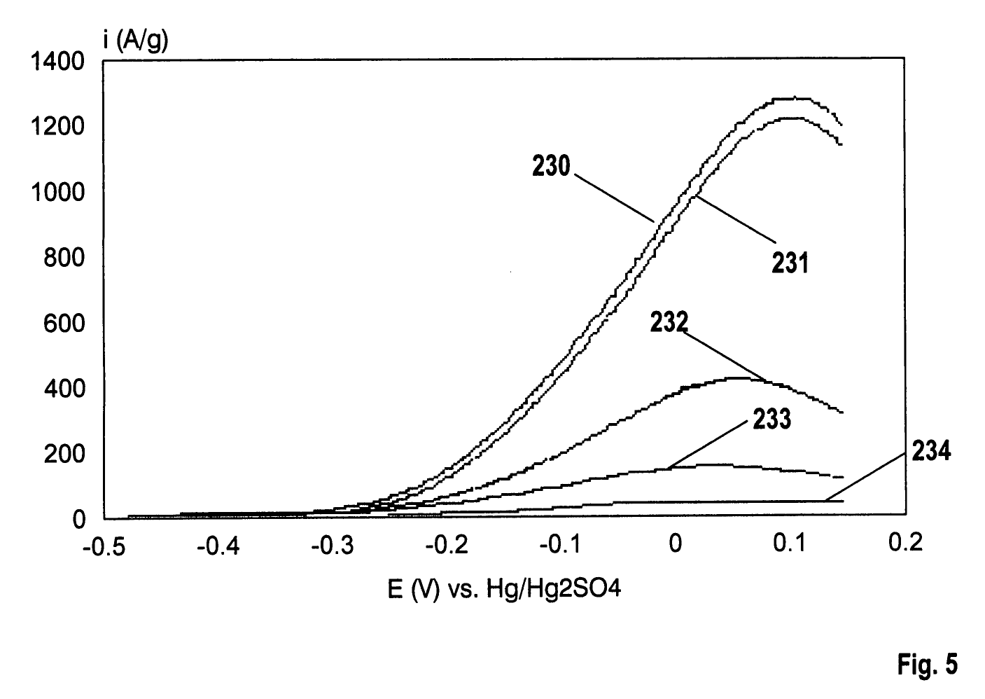

The same trend is observed for Pt:Ru black (1:1 atomic ratio), as illustrated in FIG. 4, wherein (220) is the scan relative to the sample of Example 3, and (221) is an archive scan relative to an unsupported Pt.Ru black obtained via sulfite acid route. FIG. 5 shows that the ratio of Pt:Ru significantly influences on the methanol oxidation rate. The catalytic activity increases dramatically with the ratio of Pt:Ru. Catalytic activity of catalyst with Pt:Ru 2:1 in accordance with Example 6 (230) is about three times of that for Pt:Ru 1:1 of Example 3 (232) according to the peak current. However, the catalyst of Example 7 with Pt:Ru 3:1 (231) exhibits similar activity to Pt:Ru 2:1 (230). Catalysts with Pt:Ru ratio less that I have less activity than catalysts with Pt:Ru ratio equal to or higher than 1: for instance, (233) is the scan for PtRu₂ of Example 5, (234) is that of PtRu₃ of Example 4. These data indicated that Pt:Ru catalyst reaches the maximum of mass activity (current per gram) when Pt:Ru ratio is around 2:1.

Various modifications of the invention may be made without departing from the spirit or scope thereof and it is to be understood that the invention is intended to be limited only as defined in the appended claims.

1. A method for the production of an alloyed platinum-ruthenium catalyst comprising preparing a first solution containing a platinum precursor and a second solution containing a ruthenium precursor, one of said two solutions begin/basic and the other being acidic, and mixing said first solution and said second solution until obtaining a final solution of pH between 4 and 10 and simultaneously precipitating platinum and ruthenium hydrous oxides and/or hydroxides.

2. The method of claim 1 wherein said first solution containing a platinum precursor is basic and contains at least one member selected from the group consisting of K2Co3 Na2CO3, KOH and NaOH.

3. The method of claim 2 wherein said platinum precursor is platinic acid.

4. The method of claim 1 wherein said second solution is acidic and said ruthenium precursor is RuCl3.

5. The method of claim 4 wherein said second solution further contains an acid.

6. The method of claim 1 wherein said second solution containing a ruthenium precursor is a basic solution containing RuO4-2 ions, and said first solution is an acidic solution of platinic acid.

7. The method of claim 6 wherein said basic solution containing RuO4-2 ions is obtained by reacting RuCl3 and hypochlorite ion in a sodium hydroxide solution.

8. The method of claim 1 wherein at least one of said two solutions contains a suspended carbon powder.

9. The method of claim 8 wherein said carbon powder is a conductive carbon black.

10. The method of claim 1 wherein said precipitated platinum and ruthenium hydrous oxides and/or hydroxides are subsequently reduced by addition of a reducing agent to said final solution.

11. The method of claim 10 wherein said reducing agent is selected from the group consisting of formaldehyde, formic acid, borohydride and phosphite.

12. The method of claim 1 wherein said precipitated platinum and ruthenium hydrous oxides and/or hydroxides are reduced in a gas stream containing hydrogen at elevated temperature after filtering and drying.

13-18. (canceled)

19. The method of claim 5 wherein the acid is acetic acid.

20. (canceled)

21. A gas diffusion electrode structure incorporating an alloyed platinum-rhodium catalyst obtained by the method of claim 1.
